(19) United States
(12) Patent Application Publication
(10) Pub. No.: US 2007/0025734 A1
(43) Pub. Date: Feb. 1, 2007

(54) PON system and logical link allocation method

(75) Inventors: Sadaichirou Oogushi, Tokyo (JP); Masashi Tanaka, Tokyo (JP)

Correspondence Address: Paul J. Esatto, Jr.;Scully, Scott, Murphy & Presser, 400 Garden City Plaza, Garden City, NY, 11530, US

(73) Assignee: NEC Corporation, Tokyo (JP)

(21) Appl. No.: 11/493,993

(22) Filed: Jul. 27, 2006

(30) Foreign Application Priority Data
Jul. 28, 2005 (JP) 219234/2005

(51) Int. Cl. H04J 14/00

(52) U.S. Cl. 398/71

(57) ABSTRACT

A PON (Passive Optical Network) system, which is installed in an access network for connecting a user terminal to a network and can improve the utilization efficiency of the network, is provided. The PON system comprises an OLT (Optical Line Terminal) and at least one ONU (Optical Network Unit), and the OLT connects with the network and the ONU accommodates a user terminal and connected to the OLT via an optical fiber. A logical link generation or deletion condition table and a logical link identifier management table are provided for allocating logical links to be used between the OLT and the ONU. The logical link generation or deletion condition table defines generation or deletion conditions of logical link depending on the traffic (or service) class indicated by contents of a packet passing through the PON system. The logical link identifier management table contains logical link information to be allocated, and a content of this table is added or deleted by the control with referring to the logical link generation or deletion condition table. Whenever the packet is received, the PON system peeps in the contents of the packet, and allocates an appropriate logical link in accordance with the contents.

### BACKGROUND OF THE INVENTION

1. Field of the Invention

The present invention relates to a PON (Passive Optical Network) system and a logical link allocation method.

2. Description of the Related Art

An access network such as an FTTH (Fiber To The Home) that provides Internet connections employing optical fibers is known. The optical fiber allows high-speed communications but has higher introduction costs than that of copper wire, which impeded the spread of the FTTH.

Thus, a PON system in which one optical fiber is shared among plural users to suppress the introduction costs of FTTH is well known. The configuration of a typical PON system is disclosed in Japanese Patent Application Laid-Open No. 2004-312633. FIG. 18 is a control block diagram of the typical PON system 100 as disclosed in this document. The PON system 100 comprises an OLT (Optical Line Terminal) 102 for connecting to a network 101, and a plurality of ONUs (Optical Network Unit) 108 each connecting to a user terminal 103 and connected to the OLT 102 via an optical fiber 105 split into a plurality of paths by an optical signal splitter 104.

At present, a GEPON (Gigabit Ethernet (registered trademark) Passive Optical Network) system that evolves from the above PON system is well known. The GEPON system provides the bi-directional 1 Gbps services, applying an Ethernet technology of Gigabit conventionally employed in the LAN (Local Area Network). The basic configuration of the GEPON system is the same as the PON system as shown in FIG. 18. Thus, the PON system 100 will be described below as the GEPON 100.

In the GEPON system 100, when the data is transmitted in a down direction, or in a direction from the OLT 102 to the ONUs 108, the OLT 102 performs the broadcasting and each ONU 108 selectively receives the data. On the other hand, when the data is transmitted in an up direction, there is the possibility that the plurality of ONUs 108 may transmit the data to the OLT 102 at the same time. Therefore, the time slot is allocated to each ONU 108, and the up-stream data is multiplexed in time division. That is, a specific logical path exists between the OLT 102 and the ONU 108. This path is called a logical link.

To identify the logical link, a logical link identifier is defined by the IEEE (Institute of Electrical and Electronics Engineers, Inc.) 802.3ah, and allocated to each ONU 108 in accordance with an MPCP (Multi-Point Control Protocol). The three major functions of the MPCP are listed below. A first function of the MPCP is that the OLT 102 recognizes the plurality of ONUs 108. This first function further includes a function of measuring an RTT (Round Trip Time) required to make the communication between each ONU 108 and the OLT 102, or a round trip delay time from the OLT 102 to each ONU 108, and a function of appending the logical link identifier. A second function of the MPCP is a multiplex control function of allocating the time slot to each ONU 108 and multiplexing an up burst signal from each ONU 108 on the time axis. A third function of the MPCP is a time synchronization function between each ONU 108 and the OLT 102. The logical link identifier is employed to judge whether or not each ONU 108 can transmit or receive the data. Also, the logical link identifier is employed to discriminate each ONU 108 in the PON section (interval of the optical fiber 105 in FIG. 18) and as a computation object for dynamic allocation of the band in the up direction transmission.

FIG. 19 is a control block diagram of a GEPON system 120 adopting a conventional logical link identifier allocation method as disclosed in a non-patent document, titled “IEEE802.3ah”, by IEEE Computer Society, published on 7 Sep., 2004. The basic configuration of the GEPON system 120 is the same as the PON system 100 as shown in FIG. 18. Accordingly, the explanation about the basic configuration is omitted. In the GEPON system 120, the OLT 102 and the ONUs 108-1 to 108-n are connected with each other via physical connection means 121-1 to 121-n such as the optical fiber. Further, the logical links 122-1 to 122-n are, set for each of the physical connection means 121-1 to 121-n. In this case, the operator of the GEPON 120 sets a predetermined number of logical links and the logical link identifiers to be allocated from a network management system (NMS: Network Management System), an apparatus CLI (Command Line Interface) or the like. The logical links 122-1 to 122-n are established by those settings.

However, the non-patent document does not particularly disclose the method for allocating the logical link identifier. Accordingly, in the case where the logical link identifier is individually allocated for each service, such as multicast distribution, video on-demand or voice, there is a risk that the first to third problems as described below may occur.

A first problem will be described below. In the conventional logical link identifier allocation method, the logical link identifier is statically allocated in advance in accordance with the predetermined contents. Since the logical link identifier is statically allocated, an up band secured by the logical link is wasted when the allocated logical link is not used. Accordingly, there is a risk that the up band is compressed, and the utilization efficiency of the network is lowered.

A second problem will be described below. With the conventional logical link identifier allocation method, it is necessary to make the settings in advance from the network management system or the like to the apparatus to generate or delete the logical link. Accordingly, it takes a considerable amount of time to change over the services, and it is expected that the operator is forced to make a complex setting change operation. Further, if the setting change operation is complex, it is anticipated that a situation such as a service interruption due to an artificial mistake occurs.

A third problem will be described below. With the conventional logical link identifier allocation method, the allocation of the logical link is made on an ONU basis. Therefore, since a QoS (Quality of Service) control is performed on a logical link basis, the QoS control for each service can not be made. Accordingly, the QoS of the network can not be fully secured.

On the other hand, Japanese Patent Application Laid-Open No. 2004-343243 discloses that the OLT snoops a multicast IP (Internet Protocol) message, and controls the settings of the multicast logical link in accordance with the snooped result.

However, even with this method, the third problem is not still solved.

### SUMMARY OF THE INVENTION

The exemplary feature of the present invention is to provide a PON system and a logical link allocation method in which the utilization efficiency of the network can be increased without requiring the extra load.

In a first aspect of the present invention, a PON system installed in an access network connecting user terminals to a network includes an OLT connecting with the network, and at least one ONU connected to the OLT via an optical fiber and accommodating the user terminals. And, the OLT includes a first logical link management table which manages a logical link to be allocated in an interval of the optical fiber associated with the information contained in a passing packet, a first update condition definition table which defines the update conditions for adding or deleting the logical link managed by the first logical link management table, a first table update section which acquires the first information contained in the passing packet, determines whether or not the first information is matched with the update conditions as defined in the first update condition definition table and updates the first logical link management table based on this determination result, and a first logical link allocation section which acquires the second information contained in a down-stream packet received from the network, determines whether or not the second information is associated with the information as defined in the first logical link management table, and allocates the logical link corresponding to the information as defined in the first logical link management table based on this determination result.

In a second aspect of the present invention, a PON system installed in an access network connecting user terminals to a network includes an OLT connecting with the network; and a plurality of ONUs each connected to the OLT via an optical fiber split into a plurality of paths by an optical signal splitter and accommodating the user terminals. And, the ONU includes a third logical link management table which manages a logical link to be allocated in an interval of the optical fiber associated with the information contained in a passing packet, a second update condition definition table which defines the update conditions for adding or deleting the logical link managed by the third logical link management table, a third table update section which acquires the fourth information contained in the passing packet, determines whether or not the fourth information is matched with the update conditions as defined in the second update condition definition table and updates the third logical link management table based on this determination result, and a third logical link allocation section which acquires the fifth information contained in an up-stream packet received from the user terminal, determines whether or not the fifth information is associated with the information as defined in the third logical link management table, and allocates the logical link corresponding to the information as defined in the third logical link management table based on this determination result.

In a third aspect of the present invention, a logical link allocation method for use in a PON system installed in an access network connecting user terminals to a network includes the steps of: setting a first update condition definition table defining the update conditions for adding or deleting the logical link managed by a first logical link management table, acquiring the first information contained in the passing packet, determining whether or not the first formation is matched with the update conditions as defined in the first update condition definition table, updating the first logical link management table based on this determination result, acquiring the second information contained in a down-stream packet received from the network, determining whether or not the second information is associated with the information as defined in the first logical link management table, and allocating the logical link corresponding to the information as defined in the first logical link management table based on this determination result.

In a fourth aspect of the present invention, a logical link allocation method for use in a PON system installed in an access network connecting user terminals to a network includes the steps of: setting a second update condition definition table defining the update conditions for adding or deleting the logical link managed by a third logical link management table, acquiring the fourth information contained in the passing packet, determining whether or not the fourth information is matched with the update conditions as defined in the second update condition definition table, updating the third logical link management table based on this determination result, acquiring the fifth information contained in an up-stream packet received from the user terminal, determining whether or not the fifth information is associated with the information as defined in the third logical link management table, and allocating the logical link corresponding to the information as defined in the third logical link management table based on this determination result.

In the invention, the logical link is dynamically allocated in accordance with the contents of the packet passing through the PON system. Accordingly, no logical link not actually used is set wastefully. That is, the use of logical link can be concentrated on the traffic actually required, so that the utilization efficiency of the network can be increased.

Also, the dynamic control for logical link allocation is automatically performed by judging whether or not the contents of the packet passing through the PON system are matched with the update conditions in a condition definition table defining the update conditions for adding or deleting the logical link. That is, in the invention, the system operator only needs to set the condition definition table. Accordingly, the invention makes it possible to easily increase the utilization efficiency of the network without forcing the system operator to take the extra load.

### BRIEF DESCRIPTION OF THE DRAWINGS

The above and other objects, features and advantages of the present invention will become more apparent from the following detailed description when taken in conjunction with the accompanying drawings wherein:

FIG. 1 is a control block diagram of a PON system according to a first embodiment of the invention;

FIG. 2 is a control block diagram of an OLT constituting the PON system according to the first embodiment;

FIG. 3 is one example of a logical link identifier management table;

FIG. 4 is one example of a logical link generation or deletion condition table;

FIG. 5 is a control block diagram of an ONU constituting the PON system according to the first embodiment;

FIG. 6 is a flowchart for explaining the operation of the OLT constituting the PON system according to the first embodiment;

FIG. 7 is a flowchart for explaining the operation of the ONU constituting the PON system according to the first embodiment;

FIG. 8 is a control block diagram of a modified embodiment of the OLT constituting the PON system according to the first embodiment;

FIG. 9 is a control block diagram of a modified embodiment of the ONU constituting the PON system according to the first embodiment;

FIG. 10 is a control block diagram of a PON system according to a second embodiment of the invention;

FIG. 11 is a control block diagram of an OLT constituting the PON system according to the second embodiment;

FIG. 12 is a control block diagram of an ONU constituting the PON system according to the second embodiment;

FIG. 13 is a flowchart for explaining the operation of the OLT constituting the PON system according to the second embodiment;

FIGS. 14 and 15 are flowcharts for explaining the operation of the ONU constituting the PON system according to the second embodiment;

FIG. 16 is a control block diagram of a modified embodiment of the OLT constituting the PON system according to the second embodiment;

FIG. 17 is a control block diagram of a modified embodiment of the ONU constituting the PON system according to the second embodiment;

FIG. 18 is a control block diagram of the general PON system; and

FIG. 19 is a control block diagram of a GEPON for explaining the related art logical link allocation method.

### DETAILED DESCRIPTION OF THE EXEMPLARY EMBODIMENTS

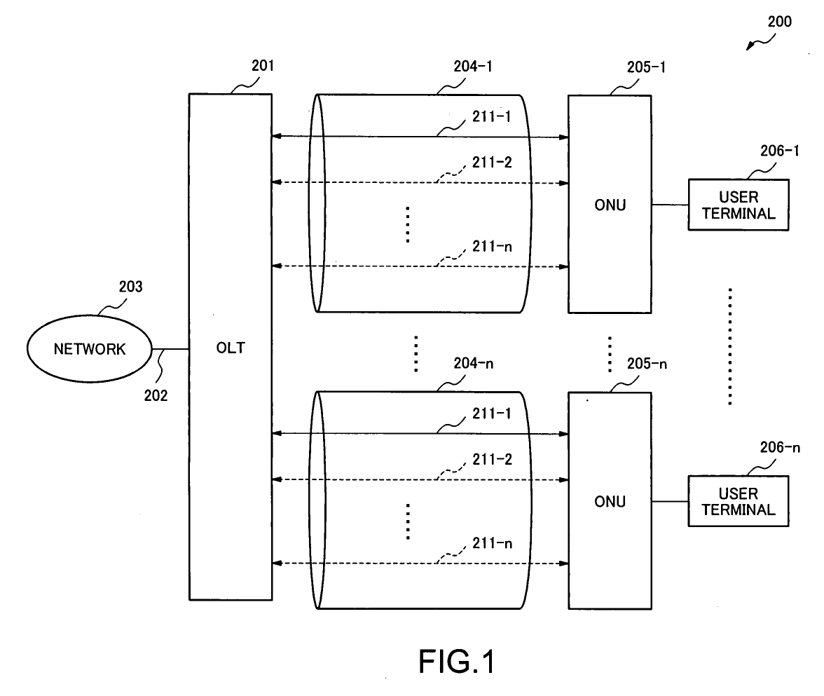

FIG. 1 is a control block diagram of a PON system 200 according to a first embodiment of the present invention. The PON system 200 comprises an OLT (Optical Line Terminal) 201 for connecting to a network 203 to be accessed by user terminals 206-1 to 206-n, and a plurality of ONUs (Optical Network Unit) 205-1 to 205-n each connecting to the respective user terminals 206-1 to 206-n. The OLT 201 and the ONUs 205-1 to 205-n are physically connected with each other by physical connection means 204-1 to 204-n such as optical fibers split into a plurality of paths by an optical signal splitter, not shown. The network 203 and the OLT 201 are connected via an interface 202 conforming to the Ethernet (registered trademark). The standard of physical connection means 204-1 to 204-n may be the 1000BASE-PX, for example.

A plurality of logical links 211-1 to 211-n are set for each of the physical connection means 204-1 to 204-n. The logical links 211-1 to 211-n can be classified into two kinds. A first logical link is the logical link 211-1 as indicated by the solid line in FIG. 1. This logical link 211-1 is established by an MPCP as defined in the IEEE802.3ah, and always exists for a certain period, for example, a period while the ONUs 205-1 to 205-n of concern are being authenticated by the OLT 201. In the following, this logical link 211-1 is called the monitor logical link 211-1. On the other hand, the second logical link is the logical links 211-2 to 211-n as indicated by the dotted line in FIG. 1. These logical links 211-2 to 211-n do not always exist, unlike the monitor logical link 211-1, but may be arbitrarily established or deleted under the control of the OLT 201 or the ONUs 205-1 to 205-n. Of course, it is possible to make the communications only using the monitor logical link 211-1 without establishing any other logical links 211-2 to 211-n.

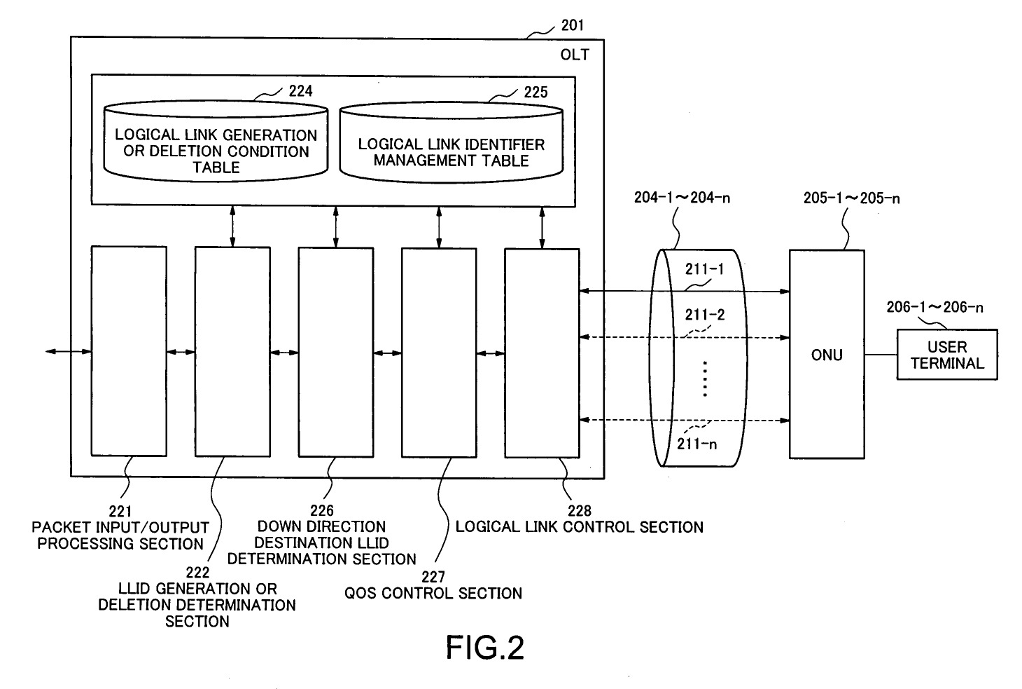

FIG. 2 is a control block diagram of the OLT 201 constituting the PON system 200 according to the first embodiment. The OLT 201 comprises a packet input/output processing section 221, an LLID (Logical Link Identification) generation or deletion determination section 222, a down direction destination LLID determination section 226, a QoS control section 227, a logical link control section 228, a logical link generation or deletion condition table 224, and a logical link identifier management table 225.

The packet input/output processing section 221 makes the timing control or error control for the transmission or reception of packets. The LLID generation or deletion determination section 222 monitors the passing packet, and determines whether or not the packet has the contents matched with the conditions as defined in the logical link generation or deletion condition table 224. The LLID generation or deletion determination section 222 updates the logical link identifier management table 225 based on this determination result. When the logical link identifier management table 225 is updated, the LLID generation or deletion determination section 222 notifies the updated contents to the ONUs 205-1 to 205-n, employing an OAM (Operations, Administration and Maintenance) packet. The “passing packet” includes both the up-stream packet received through the PON section from the ONUs 205-1 to 205-n and the down-stream packet received from the network 203. The down direction destination LLID determination section 226 retrieves the logical link identifier management table 225 by peeping into the information (e.g., Ethernet header, IP header, IP payload) of each of the layers 2, 3 and 4 for the down-stream packet, and decides the logical link identifier of destination from the matched conditions. The QoS control section 227 makes the priority control regarding the transmission or reception of packet in accordance with the logical link identifier or the kind of packet. The logical link control section 228 makes the timing control, appends or deletes the logical link, and determines the error for the transmission or reception in the PON section.

That is, a first feature of the PON system 200 according to this embodiment is a point that the OLT 201 dynamically allocates the logical link in the PON section in accordance with the contents of packet passing through itself. Specifically, the OLT 201 acquires the contents of the passing packet, determines whether its contents mean addition or deletion of the logical link, and dynamically allocates the logical link based on the determination result. The addition/deletion conditions are defined in the logical link generation or deletion condition table 224.

Also, a second feature of the PON system 200 according to this embodiment is a point that the logical link dynamically allocated in the PON section is managed by the logical link identifier management table. The entry contents of the logical link identifier management table are updated successively based on the logical link addition/deletion determination result.

Moreover, a third feature of the PON system 200 according to this embodiment is a point that the OLT 201 and the ONUs 205-1 to 205-n have the logical link identifier management table, the contents of which are notified by the OAM packet and always kept consistent.

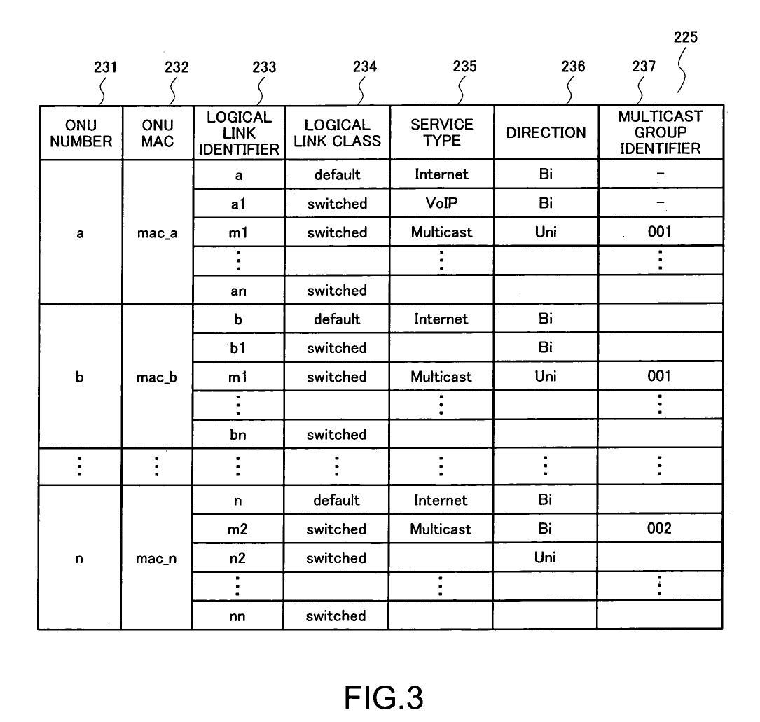

FIG. 3 is one example of the logical link identifier management table 225. The logical link identifier management table 225 is composed of an ONU number 231 that can be uniquely specified, an MAC (Media Access Control) address (ONU MAC) 232 that the ONU 205-1 to 205-n has, a logical link identifier 233, a logical link class 234 representing a classification of the monitor logical link 211-1 fixedly allocated and the logical links 211-2 to 211-n dynamically allocated, a service type 235, a direction (Direction) 236 representing whether the nature of applicable logical link is uni-direction or bi-direction, and a multicast group identifier 237.

The service type 235 is the information derived from contents defined in each of the layers 2, 3 and 4 of the packet and employed to identify the traffic class of the passing packet. For example, when the service type 235 is “Internet”, it means the Internet data communication traffic, and when the service type 235 is “VoIP (Voice over IP)”, it means the voice traffic. Also, when the service type 235 is “Multicast”, the Point-to-MultiPoint communication traffic is meant. For example, it is supposed to define the “Multicast” for the packet having the applicable IP multicast address as the transmission destination address. A QoS process is performed for every logical link as defined in the logical link identifier management table 225.

The “Uni” of the Direction 236 means the “Unidirectional”, or single direction, and the “Bi” means the “Bi-Directional” or both directions. When the Direction 236 is unidirectional, the applicable logical link is dedicated for the communication in the down direction, and not used for the communication in the up direction. The multicast group identifier 237 is employed for grouping the unidirectional communications. All the entries having the same multicast group identifier are given the same logical link identifier 233, to implement a transmission method, namely multicast, for enabling the plurality of ONUs 205-1 to 205-n to receive the same packet in the down direction at the same time.

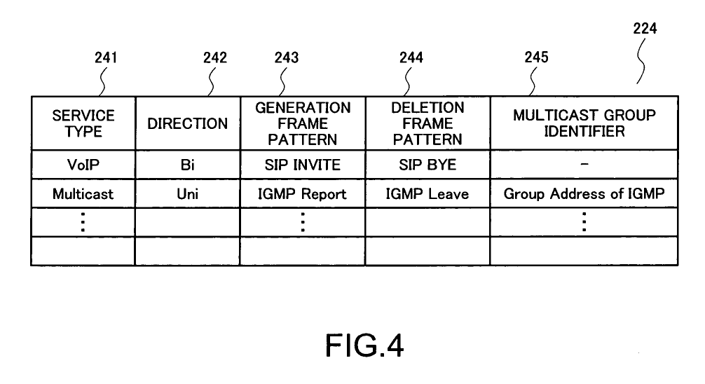

FIG. 4 is one example of the logical link generation or deletion condition table 224. The logical link generation or deletion condition table 224 is composed of a service type 241, a direction (Direction) 242, a generation frame pattern 243, a deletion frame pattern 244 and a multicast group identifier 245. For example, the OLT 201 peeps into the information of each of the layers 2, 3 and 4 for the passing packet, and if that information is matched with the generation frame pattern 243, an entry of the logical link identifier management table 225 is added. And the OLT 201 notifies the contents of the added entry to the ONUs 205-1 to 205-n. On the other hand, if the information of each of the layers 2, 3 and 4 is matched with the deletion frame pattern 244, the OLT 201 deletes the entry of the logical link identifier management table 225, and notifies the contents of the deleted entry to the ONUs 205-1 to 205-n. Herein, an instance where the service type 241 is “Multicast” will be described below. The OLT 201 monitors the IGMP as a protocol for managing whether to participate in or leave from the multicast service. If the OLT 201 receives an “IGMP Report” message requesting the participation, it allocates the applicable logical link, because the matched condition of “IGMP Report” exists in the generation frame pattern 243, while if the OLT 201 receives an “IGMP Leave” message requesting the leave, it releases the applicable logical link, because the matched condition of “IGMP Leave” exists in the deletion frame pattern 244.

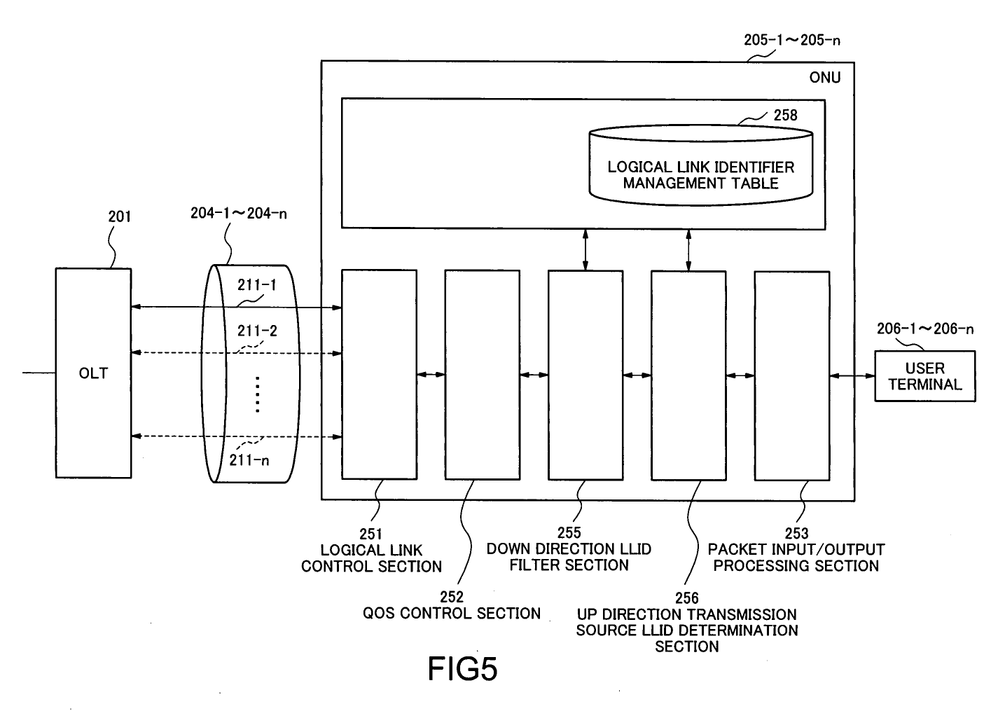

FIG. 5 is a control block diagram of the ONUs 205-1 to 205-n constituting the PON system 200 according to the first embodiment. The ONUs 205-1 to 205-n comprise a logical link control section 251, a QoS control section 252, a down direction LLID filter section 255, an up direction transmission source LLID determination section 256, a packet input/output processing section 253, and a logical link identifier management table 258.

The logical link control section 251 makes the timing control, appends or deletes the logical link, and determines the error for the transmission or reception in the PON section. The QoS control section 252 makes the priority control regarding the packet transmission or reception in accordance with the logical link identifier or the kind of packet. The down direction LLID filter section 255 receives a down-stream packet, namely a packet received from the OLT 201 and transmitted to the user terminal 206, and determines whether the down-stream packet is passed or discarded, based on the logical link identifier management table 258.

The up direction transmission source LLID determination section 256 peeps into the information of each of the layers 2, 3 and 4 for the up-stream packet, namely, the packet received from the user terminal 206 and transmitted to the PON section, and retrieves the logical link identifier management table 258. And the up direction transmission source LLID determination section 256 decides the logical link identifier of transmission source from the matched conditions.

The packet input/output processing section 253 makes the timing control and the error control for the transmission or reception of the packet. The logical link identifier management table 258 is the same as the logical link identifier management table 225 provided for the OLT 201 as already explained in connection with FIG. 3. The logical link identifier management table 258 is kept in the same contents as the OLT 201 at any time, based on the update information notified from the OLT 201 by the OAM packet.

The operation of the PON system 200 according to the first embodiment of the invention will be described below.

If the PON system 200 is started, the OLT 201 initializes the logical link identifier management table 225, and the ONUs 205-1 to 205-n initialize the logical link identifier management table 258. Next, the OLT 201 registers each monitor logical link 211-1 for the ONUs 205-1 to 205-n in connected state in the initialized logical link identifier management table 225. The OLT 201 notifies the registered contents to the ONUs 205-1 to 205-n, using the OAM packet. The ONUs 205-1 to 205-n reflect the registered contents received from the OLT 201 to the logical link identifier management table 258 of their own.

At this stage, only the monitor logical link 211-1 corresponding to each of the ONUs 205-1 to 205-n is registered in the logical link identifier management tables 225 and 258 of the OLT 201 and the ONUs 205-1 to 205-n. After the initialization, the logical links 211-2 to 211-n are dynamically generated or deleted in accordance with the contents (or class) of the passing packet.

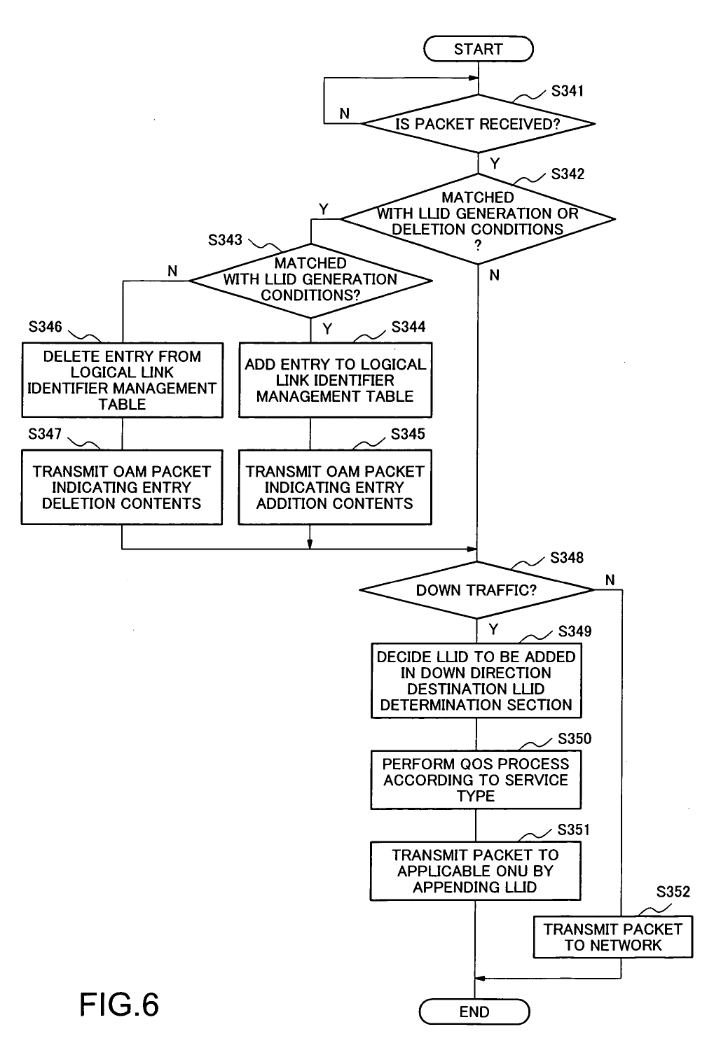

FIG. 6 is a flowchart for explaining the operation of the OLT 201 after the initialization process. The OLT 201 checks whether the packet passing through itself, namely, the down-stream packet received from the network 203 and transmitted to the PON section or the up-stream packet received from the PON section and transmitted to the network 203 has been received (step S341).

If there is any received packet, the LLID generation or deletion determination section 222 peeps into the information of each of the layers 2, 3 and 4 for the received packet, and determines whether the information is matched with the generation frame pattern 243 or the deletion frame pattern 244 as defined in the logical link generation or deletion condition table 224 (S342). If the above conditions are met, the LLID generation or deletion determination section 222 determines whether or not the packet is consistent with the generation frame pattern 243 (step S343).

If the packet is consistent with the generation frame pattern 243, the LLID generation or deletion determination section 222 adds an entry of the logical link identifier management table 225 (step S344). For example, an instance of receiving an “SIP INVITE” that is a packet transmitted at the start of the IP telephone is given below. In this case, since the “SIP INVITE” is defined in the generation frame pattern 243 of the logical link generation or deletion condition table 224 as shown in FIG. 4, the LLID generation or deletion determination section 222 adds a new entry to the logical link identifier management table 225 as shown in FIG. 3. At this time, for the packet in which the frame pattern is “SIP INVITE”, the corresponding ONU number and ONU MAC address can be specified, because the packet is received via the monitor logical link 211-1 set at the initialization in the case of up direction, or the packet includes the destination information in the case of down direction. Thus, the logical identifier “a1” is added to the ONU with the ONU number of “a”, for example. Further, the service type “VoIP” and the Direction “Bi” that are set corresponding to the generation frame pattern “SIP INVITE” in the logical link generation or deletion condition table 224 of FIG. 4 are set as the entry corresponding to “a1” in the logical link identifier management table 225. Next, the LLID generation or deletion determination section 222 transmits an OAM packet representing the entry contents added to the logical link identifier management table 225 to the applicable ONUs 205-1 to 205-n (step S345).

On the other hand, if it is determined that the packet is matched with the deletion frame pattern 244 at step S343, the LLID generation or deletion determination section 222 deletes the entry of the logical link identifier management table 225 (step S346). For example, an instance of receiving a “SIP BYE” that is a packet transmitted at the end of the IP telephone is given below. In this case, since the “SIP BYE” is defined in the deletion frame pattern 244 of the logical link generation or deletion condition table 224 as shown in FIG. 4, the LLID generation or deletion determination section 222 deletes the corresponding entry from the logical link identifier management table 225 as shown in FIG. 3. At this time, for the packet in which the frame pattern is “SIP BYE”, the logical link to be deleted can be specified, because the packet is received via the logical link having the logical link identifier “a1” set as previously described. Thus, the logical link identifier “a1” in the ONU with the ONU number “a” is deleted. Next, the LLID generation or deletion determination section 222 transmits an OAM packet representing the entry contents deleted from the logical link identifier management table 225 to the applicable ONUs 205-1 to 205-n (step S347).

After the end of the processing at step S345 or step S347, or if it is determined that the result of peeping into the packet at step S342 is neither matched with the generation frame patterns 243 nor the deletion frame pattern 244, the OLT 201 makes a determination whether or not the received packet is in the down direction (step S348).

If the received packet is in the down direction, namely, the packet received from the network 203 and transmitted to the PON section, the down direction destination LLID determination section 226 retrieves the entry in the logical link identifier management table 225, based on the information of each of the layers 2, 3 and 4 for the peeped packet, and decides the logical link identifier to be given to the packet (step S349). For example, the ONU number is specified from the destination information, and the service type is specified from the frame pattern, payload information or the like, whereby when the down-stream packet is the packet addressed to the ONU number “a”, with its service type being “VoIP”, the down direction destination LLID determination section 226 decides the logical link identifier of the packet as “a1”, as shown in FIG. 3. The QoS control section 227 identifies the service type of the packet from the decided logical link identifier, and accordingly performs the QoS process (step S350). Next, the logical link control section 228 appends the decided logical link identifier to the packet, and transmits the packet to the PON section with the applicable ONU 205-1 to 205-n as the destination (step S351).

On the other hand, if it is determined that the received packet is in the up direction at step S348, the OLT 201 transmits the packet to the network 203 (step S352).

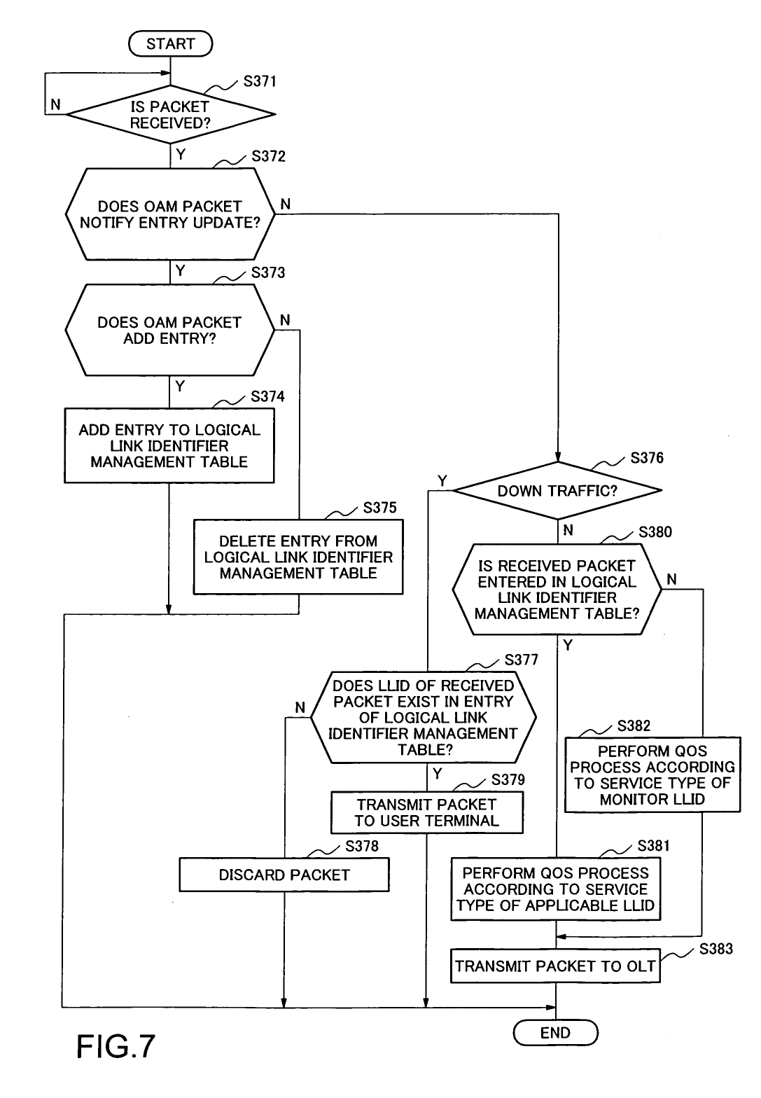

FIG. 7 is a flowchart for explaining the operation of the ONUs 205-1 to 205-n after the initialization process. The ONUs 205-1 to 205-n check whether the packet passing through themselves, namely, the down-stream packet received from the PON section and transmitted to the user terminal 206 or the up-stream packet received from the user terminal 206 and transmitted to the PON section has been received (step S371). If there is any received packet, the ONUs 205-1 to 205-n determine whether or not the received packet is the OAM packet notifying the update of the entry in the logical link identifier management table 258 (step S372). If the received packet is the OAM packet notifying the update of the entry, the ONUs 205-1 to 205-n determine whether or not the received packet is the OAM packet notifying the addition of entry in the logical link identifier management table 258 (step S373). If the received packet is the OAM packet indicating the addition of the entry, the ONUs 205-1 to 205-n generate a new entry of the logical link management information in the logical link identifier management table 258 in accordance with the contents notified by the OAM packet (step S374). If the received packet is the OAM packet indicating the deletion of the entry, the ONUs 205-1 to 205-n delete the entry of the logical link management information from the logical link identifier management table 258 in accordance with the contents notified by the OAM packet (step S375).

On the other hand, if it is determined at step S372 that the received packet is not the OAM packet notifying the update of the entry, the ONUs 205-1 to 205-n determine whether or not the transmission direction of the received packet is the down direction (step S376).

If the received packet is in the down direction, the down direction LLID filter section 255 determines whether or not the logical link identifier of the packet received from the PON section is registered in the logical link identifier management table 258 (step S377). If the logical link identifier of the received packet is not registered in the logical link identifier management table 258, the down direction LLID filter section 255 discards the received packet (step S378). If the logical link identifier of the received packet is registered in the logical link identifier management table 258, the down direction LLID filter section 255 transmits the received packet to the user terminal 206 (step S379).

On the other hand, if it is determined at step S376 that the received packet is in the up direction, the up direction transmission source LLID determination section 256 peeps into the information of each of the layers 2, 3 and 4 for the packet received from the user terminal 206, and determines whether or not the contents of the information are consistent with the contents of the entry in the logical link identifier management table 258 (step S380). And the up direction transmission source LLID determination section 256 decides the logical link identifier of transmission source from the matched conditions. For example, the service type is specified from the frame pattern or payload information of the packet in the same way as previously described, whereby when the ONU receiving this packet has the ONU number “a”, and the service type of this packet is “VoIP”, the up direction transmission source LLID determination section 256 decides the logical link identifier of the packet as “a1”, as shown in FIG. 3. The QoS control section 252 performs the priority control regarding the packet transmission or reception in accordance with the service type corresponding to the kind of the applicable logical link identifier (step S381). If the logical link identifier corresponding to the received packet does not exist in the logical link identifier management table 258, the monitor logical link 211-1 is allocated as the default. Also, the QoS control section 252 performs the QoS process in accordance with the service type corresponding to the monitor logical link 211-1 (step S382). After the QoS processing at step S381 or step S382, the logical link control section 251 appends the decided logical link identifier to the packet and transmits the packet to the PON section (step S383).

As described above, the logical link is allocated corresponding to the traffic class (service class) of the packet by referring to the information of each of the layers 2, 3 and 4 of the passing packet. And the QoS control is performed in accordance with the service type corresponding to the logical link.

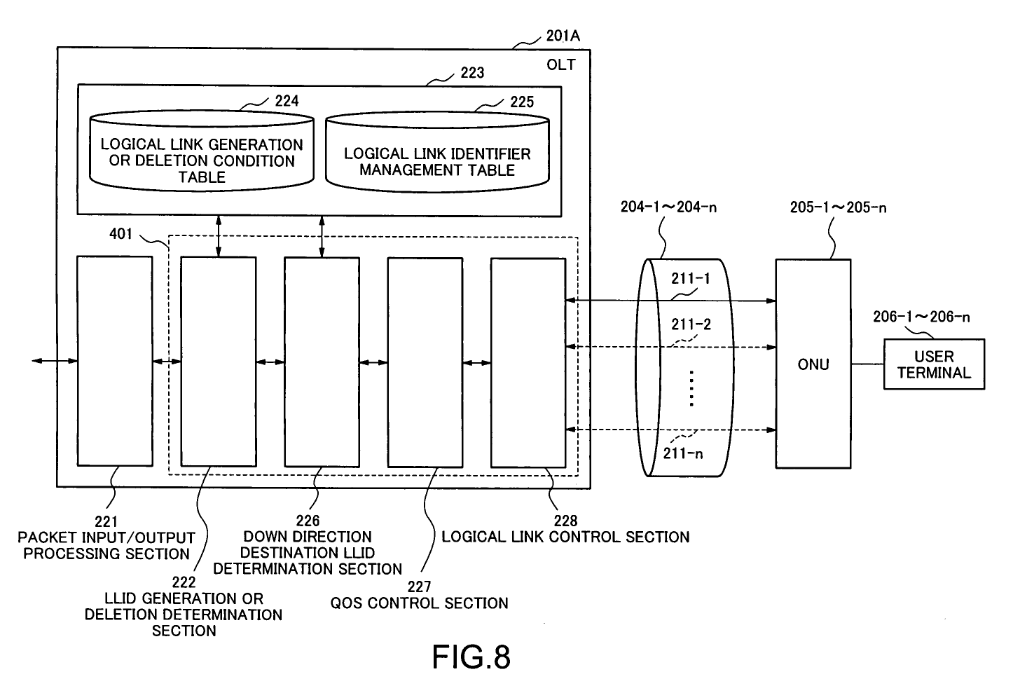

FIG. 8 is a control block diagram of an OLT 201A according to a modified embodiment of the OLT 201 as shown in FIG. 2. A feature of the OLT 201A is that the LLID generation or deletion determination section 222, the down direction destination LLID determination section 226, the QoS control section 227 and the logical link control section 228 are modularized as one IC chip 401. A circuit portion closely related with the logical link control is modularized as one chip, whereby if any other circuit portion is changed, the portion related with the logical link control can be diverted. Thereby, the manufacturing cost of the PON system 200 can be reduced, and the design or improvement efficiency of the system can be increased.

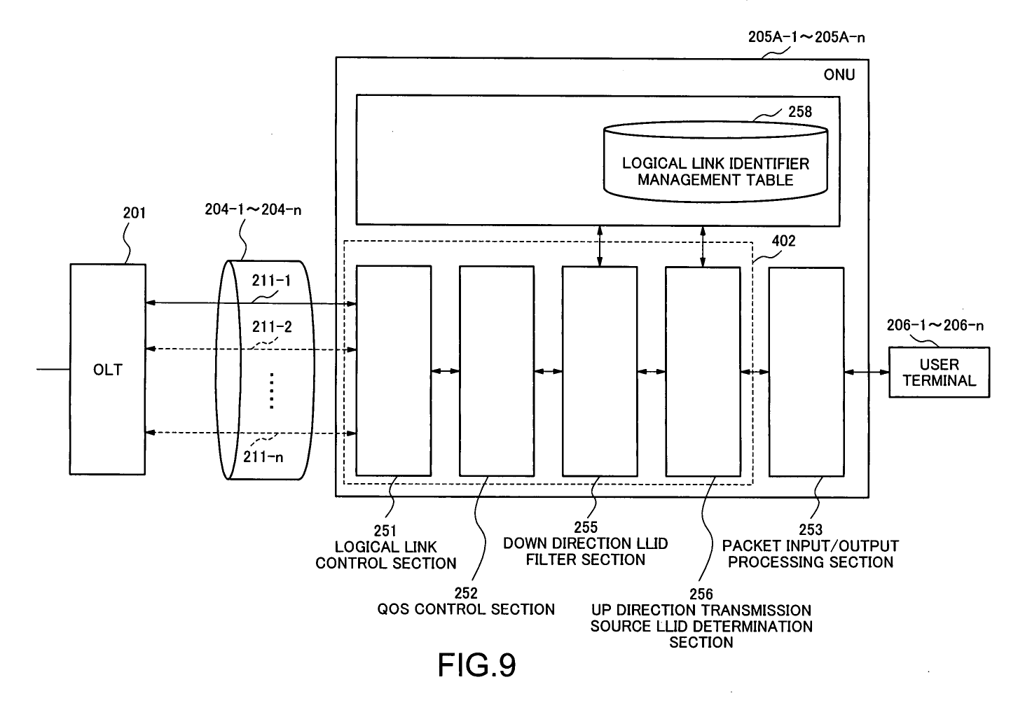

FIG. 9 is a control block diagram of the ONUs 205A-1 to 205A-n according to a modified embodiment of the ONUs 205-1 to 205-n as shown in FIG. 5. A feature of the ONUs 205A-1 to 205A-n is that the logical link control section 251, the QoS control section 252, the down direction LLID filter section 255 and the up direction transmission source LLID determination section 256 are modularized as one IC chip 402. Accordingly, for the above reason, the manufacturing cost of the PON system 200 can be reduced, and the design or improvement efficiency of the system can be increased.

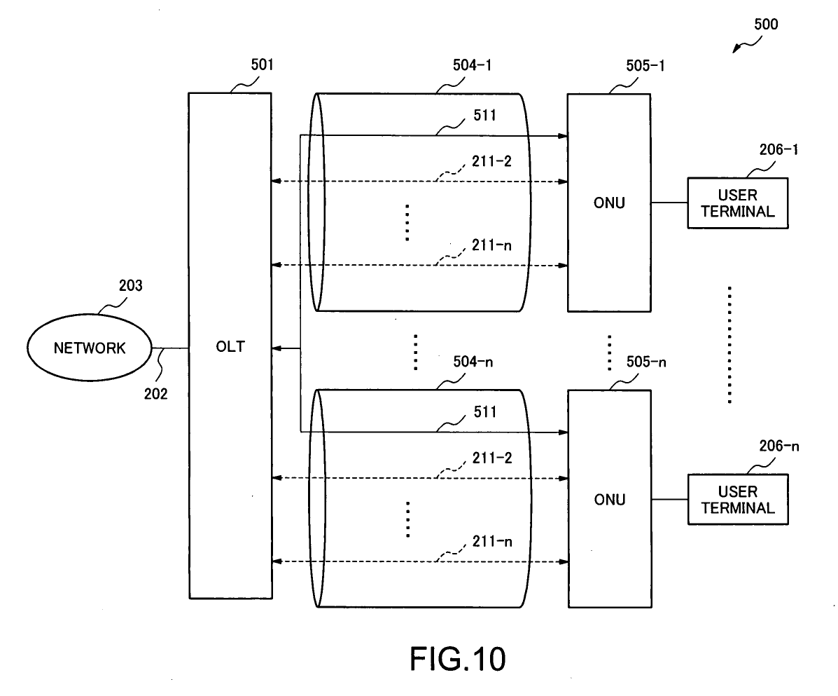

FIG. 10 is a control block diagram of a PON system 500 according to a second embodiment of the invention. The same parts are designated by the same numerals throughout FIGS. 1 and 10, and the explanation is omitted properly.

The PON system 500 comprises an OLT 501 for connecting to the network 203 to be accessed by the user terminals 206-1 to 206-n, and a plurality of ONUs 505-1 to 505-n each connecting to the respective user terminals 206-1 to 206-n. The OLT 501 and the ONUs 505-1 to 505-n are connected with each other by physical connection means 504-1 to 504-n such as optical fibers split into a plurality of paths by an optical signal splitter, not shown. The network 203 and the OLT 501 are connected via the interface 202 conforming to the Ethernet (registered trademark).

In the PON system 500, a monitor logical link 511 as indicated by the solid line is not individually allocated for the ONUs 505-1 to 505-n, as in the PON system 200, but is shared among the ONUs 505-1 to 505-n. The PON system 500 is greatly different in this point from the PON system 200. The shared monitor logical link 511 is employed for only the communication for generating or deleting the logical link between the ONUs 505-1 to 505-n and the OLT 501, but does not pass a primary signal of actual communication traffic. Since the monitor logical link 511 is shared among the ONUs 505-1 to 505-n, the OLT 501 can not identify the ONUs 505-1 to 505-n by employing the logical link identifier. Thus, the PON system 500 adopts a method for identifying the ONUs 505-1 to 505-n, employing the MAC address of the ONUs 505-1 to 505-n.

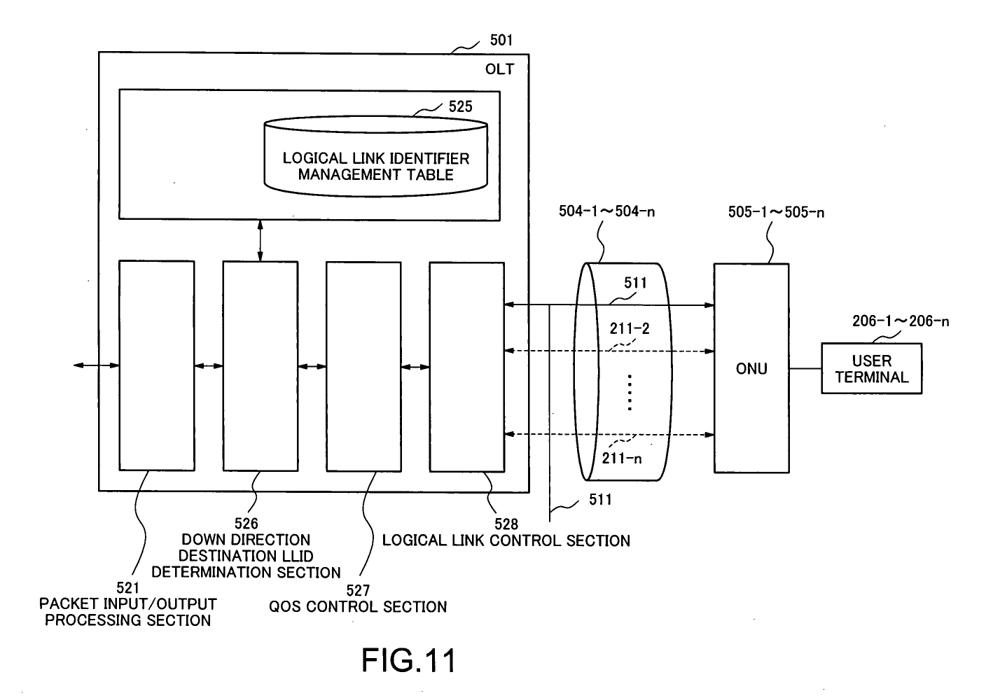

FIG. 11 is a control block diagram of the OLT 501 constituting the PON system 500 according to the second embodiment. The OLT 501 is different from the OLT 201 as shown in FIG. 2 in that the OLT 501 does not have the functions corresponding to the LLID generation or deletion determination section 222 and the logical link generation or deletion condition table 224. That is, a feature of the PON system 500 according to the second embodiment is that those functions of the OLT 201 according to the first embodiment are provided on the ONU side. The components of the OLT 501 are equivalent to those of the OLT 201 as shown in FIG. 2, and the explanation of those parts is omitted.

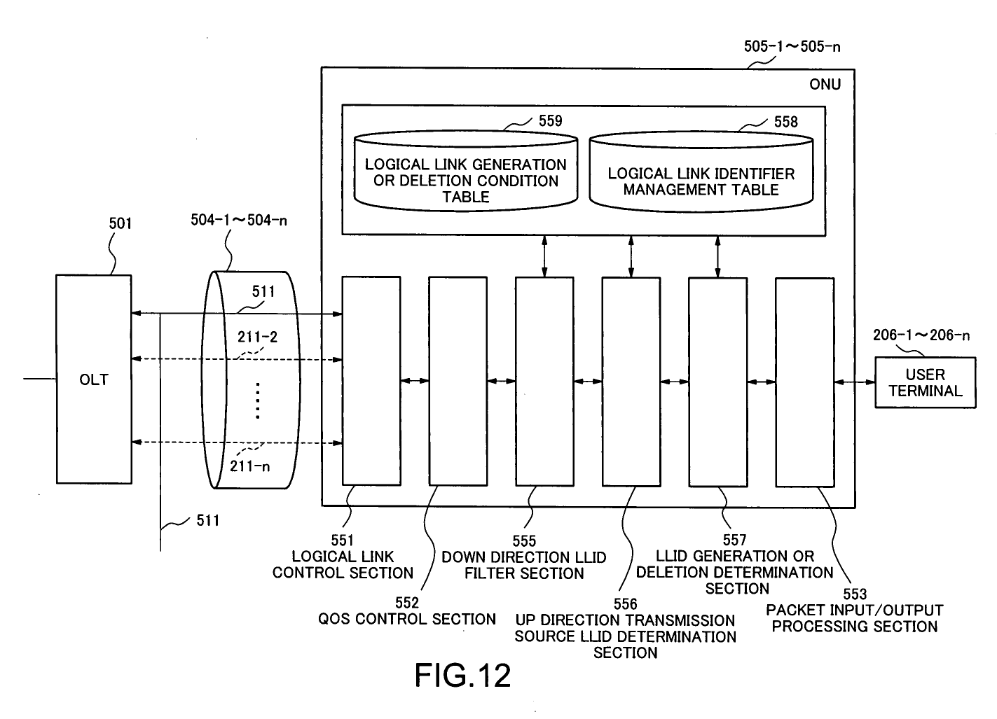

FIG. 12 is a control block diagram of the ONUs 505-1 to 505-n constituting the PON system 500 according to the second embodiment. The ONUs 505-1 to 505-n are different from the ONUs 205-1 to 205-n as shown in FIG. 5 in that an LLID generation or deletion determination section 557 and a logical link generation or deletion condition table 559 provided for the OLT 201 according to the first embodiment are provided as described above. The components other than these two new components are equivalent to those of the ONU 205-1 to 205-n as shown in FIG. 5, and the explanation of those parts is omitted.

The LLID generation or deletion determination section 557 peeps into the passing packet, and retrieves the logical link generation or deletion condition table 559. And if the conditions are matched, the LLID generation or deletion determination section 557 updates a logical link identifier management table 558. If the logical link identifier management table 558 is updated, the LLID generation or deletion determination section 557 notifies the updated contents to the OLT 501 employing the OAM packet. The “passing packet” includes both the down-stream packet received from the OLT 501 via the PON section and the up-stream packet received from the user terminals 206-1 to 206-n. The logical link generation or deletion condition table 559 is equivalent to that for the OLT 201 according to the first embodiment, and its explanation, which is already made in connection with FIG. 4, is omitted here.

The operation of the PON system 500 according to the second embodiment of the invention will be described below. If the PON system 500 is started, the OLT 501 initializes a logical link identifier management table 525 of its own, and the ONUs 505-1 to 505-n initialize the logical link identifier management table 558 of their own. The OLT 501 registers the shared monitor logical link 511 common to the ONUs 505-1 to 505-n in connected state in the initialized logical link identifier management table 525. The OLT 501 notifies the registered contents to the ONUs 505-1 to 505-n, employing the OAM packet. The ONUs 505-1 to 505-n reflect the registered contents described in the OAM packet received from the OLT 501 to the logical link identifier management table 558 of their own.

At this stage, only the shared monitor logical link 511 is registered in the logical link identifier management tables 525 and 558 of the OLT 501 and the ONUs 505-1 to 505-n. After the initialization, the logical links 211-2 to 211-n are dynamically generated or deleted in accordance with the contents (or class) of the passing packet.

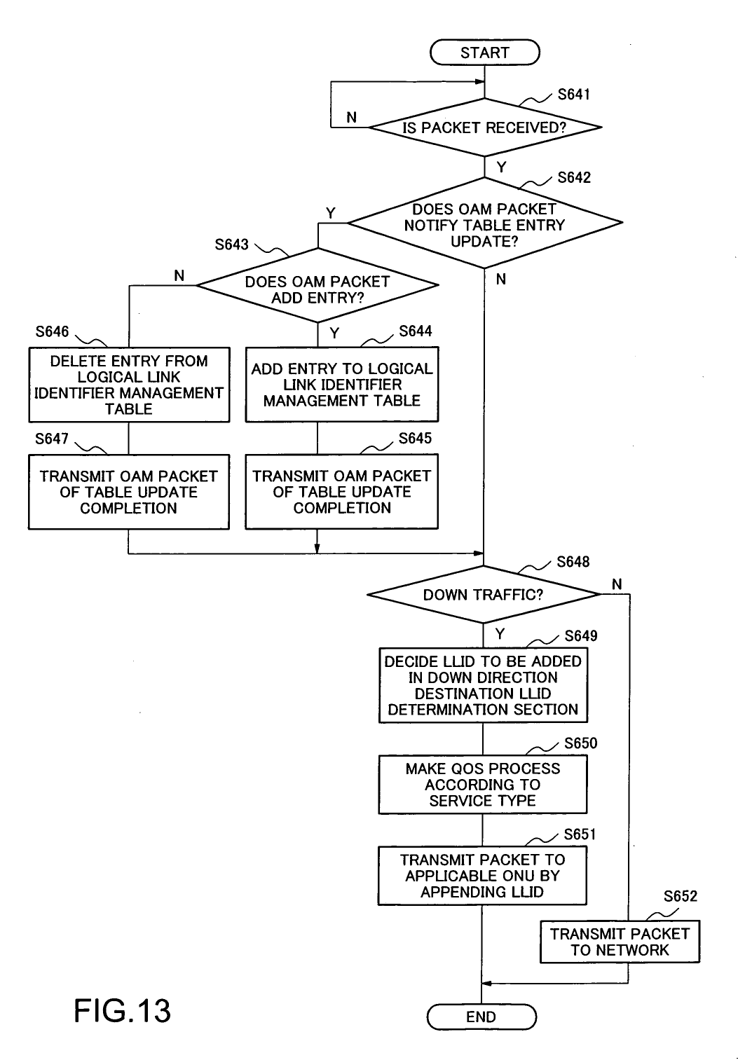

FIG. 13 is a flowchart for explaining the operation of the OLT 501 after the initialization process. The OLT 501 checks whether the packet passing through itself, namely the down-stream packet received from the network 203 and transmitted to the PON section or the up-stream packet received from the PON section and transmitted to the network 203 has been received (step S641). If there is any received packet, the OLT 501 determines whether or not the received packet is the OAM packet notifying the update of the logical link identifier management table 525 (step S642). That is, in the second embodiment, the ONUs 505-1 to 505-n control the presence or absence of updating the logical link identifier management table 525 of the OLT 501 as will be described later. And if the update of the table 525 is necessary, the OAM packet notifying its updated contents is transmitted to the OLT 501. If the received packet is the OAM packet notifying the update of the logical link identifier management table 525, the OLT 501 determines whether or not its received packet is the OAM packet indicating the addition of the entry in the logical link identifier management table 525 (step S643). If the received packet is the OAM packet indicating the addition of the entry, the OLT 501 adds the entry of the logical link identifier management table 525 in accordance with the contents notified by the OAM packet (step S644). And the OLT 501 transmits an OAM packet of the table entry update completion indicating that the entry of the logical link identifier management table 525 is added to the ONUs 505-1 to 505-n (step S645).

On the other hand, the OAM packet received at step S643 is the OAM packet indicating the deletion of the entry of the logical link identifier management table 525, the OLT 501 deletes the entry of the logical link identifier management table 525 in accordance with the contents notified by the OAM packet (step S646). And the OLT 501 transmits an OAM packet of the table entry update completion indicating that the entry of the logical link identifier management table 525 is deleted to the ONUs 505-1 to 505-n (step S647).

As described above, the OLT 501 instructed to update the logical link identifier management table 525 from the ONUs 505-1 to 505-n transmits an OAM packet notifying that the update is completed to the ONUs 505-1 to 505-n.

After the end of the processing at step S645 or step S647, or if it is determined at step S642 that the received packet is not the OAM packet notifying the update of the logical link identifier management table 525, a determination is made whether or not the received packet is in the down direction (step S648). If it is determined that the received packet is in the down direction, namely, the packet received from the network 203 and transmitted to the PON section, the down direction destination LLID determination section 526 retrieves the entry in the logical link identifier management table 525, and decides the logical link identifier to be given to the packet (step S649). The retrieval of the entry and the decision of the logical link identifier are made in the same way as described in the first embodiment. For example, when the down-stream packet is the packet addressed to the ONU number “a”, with the specified service type being “VoIP”, the down direction destination LLID determination section 526 decides the logical link identifier of the packet as the logical link identifier of “a1”, as shown in FIG. 3. The QoS control section 527 identifies the service type of the packet from the decided logical link identifier, and accordingly performs the QoS process (step S650). Next, the logical link control section 528 appends the decided logical link identifier to the packet, and transmits the packet to the PON section with the applicable ONU 505-1 to 505-n as the destination (step S651).

On the other hand, if it is determined that the received packet is in the up direction at step S648, the OLT 501 transmits the packet to the network 203 (step 8652).

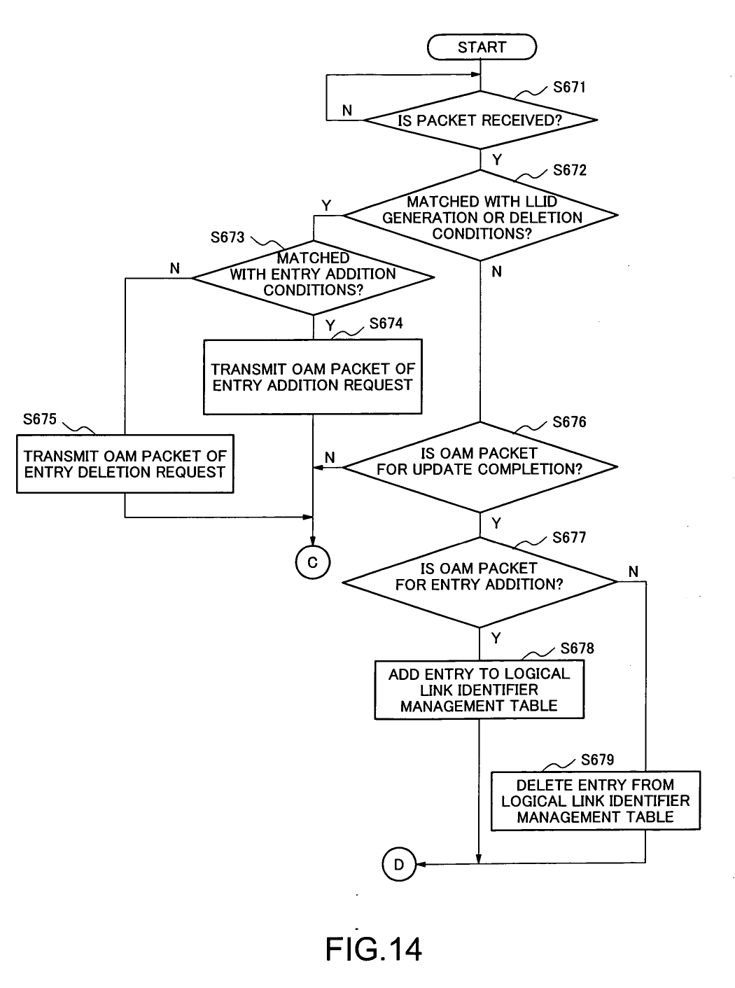

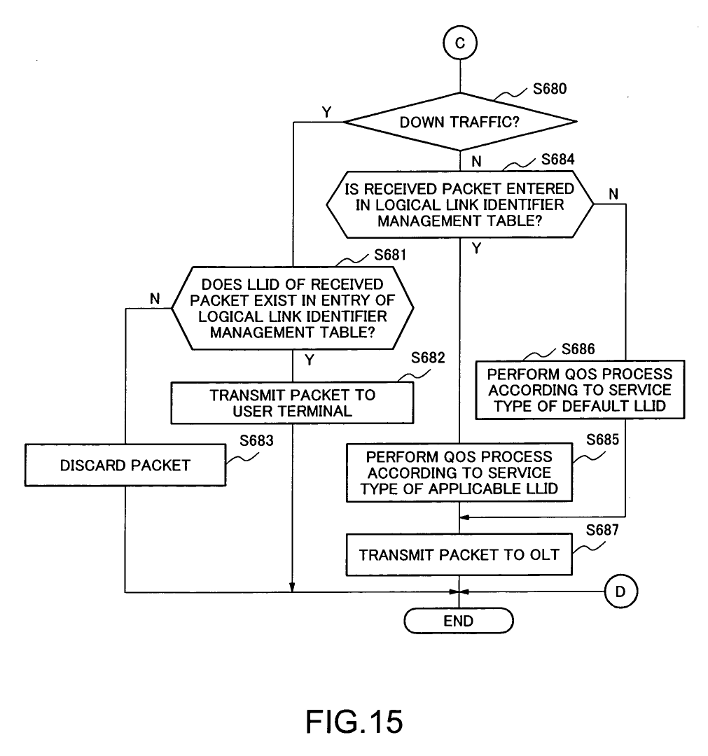

FIGS. 14 and 15 are flowcharts for explaining the operation of the ONUs 505-1 to 505-n after the initialization process. The ONUs 505-1 to 505-n check whether the packet passing through themselves, namely, the down-stream packet received from the PON section and transmitted to the user terminal 206 or the up-stream packet received from the user terminal 206 and transmitted to the PON section has been received (step S671). If there is any received packet, the LLID generation or deletion determination section 557 peeps into the information of each of the layers 2, 3 and 4 for the received packet, and determines whether or not that information is matched with the generation frame pattern 243 or the deletion frame pattern 244 as defined in the logical link generation or deletion condition table 559 (step S672).

If the above conditions are met, the LLID generation or deletion determination section 557 determines whether or not the information of the received packet is consistent with the generation frame pattern 243 (step S673).

If the information is consistent with the generation frame pattern 243, the LLID generation or deletion determination section 557 transmits an OAM packet, which is a request for adding the entry of the new logical link identifier to the logical link identifier management table 525 of the OLT 501, to the OLT 501 (step S674).

On the other hand, if it is determined at step S673 that the information is consistent with the deletion frame pattern 244, the LLID generation or deletion determination section 557 transmits an OAM packet, which is a request for deleting the entry of the applicable logical link identifier from the logical link identifier management table 525 of the OLT 501, to the OLT 501 (step S675).

The control of the LLID generation or deletion determination section 557 is the same as the control of the LLID generation or deletion determination section 222 for the OLT 201 as described in the first embodiment, wherein the contents of the entry to be added or deleted are detected. Accordingly, the OAM packet of each request to be transmitted to the OLT 501 includes the contents of the entry to be added or deleted.

On the other hand, if it is determined at step S672 that the result of peeping into the packet is neither matched with the generation frame pattern 243 nor the deletion frame pattern 244, the ONUs 505-1 to 505-n determine whether or not the received packet is the OAM packet notifying the update completion for the addition/deletion request of the logical link identifier management table 525 for the OLT 501 (step S676). If the received packet is the OAM packet notifying the update completion, the ONUs 505-1 to 505-n determine whether or not the received packet is the OAM packet notifying the update completion for the addition request of the entry (step S677). If the received packet is the OAM packet indicating the update completion for the addition request of the entry, the ONUs 505-1 to 505-n add the entry of the logical link identifier management table 558 of their own in accordance with the contents notified by the OAM packet (step S678). If the received packet is the OAM packet indicating the update completion for the deletion request of the entry, the ONUs 505-1 to 505-n delete the entry of the logical link identifier management table 558 of their own in accordance with the contents notified by the OAM packet (step S679).

That is, in the second embodiment, the ONUs 505-1 to 505-n control the update of the logical link identifier management table 525 for the OLT 501, as previously described. And when the update is necessary, the OLT 501 is instructed to update the logical link identifier management table 525, and the ONUs 505-1 to 505-n update the logical link identifier management table 558 only after the update of the logical link identifier management table 525 for the OLT 501 is completed. Thereby, both the management tables 525 and 558 are controlled to have the same contents at any time.

On the other hand, when the processing at step S674 or step S675 is ended, or if it is determined at step S676 that the received packet is not the OAM packet notifying the update completion of the addition/deletion request of the logical link identifier management table 525 for the OLT 501, the ONUs 505-1 to 505-n determine whether or not the received packet is in the down direction (step S680) If the received packet is in the down direction, the down direction LLID filter section 555 determines whether or not the logical link identifier of the packet received from the PON section is registered in the logical link identifier management table 558 (step S681).

If the logical link identifier of the received packet is registered in the logical link identifier management table 558, the down direction LLID filter section 555 transmits the received packet to the user terminal 206 (step S682).

If the logical link identifier of the received packet is not registered in the logical link identifier management table 558, the down direction LLID filter section 555 discards the received packet (step S683).

On the other hand, if it is determined at step S680 that the received packet is in the up direction, the up direction transmission source LLID determination section 556 peeps into the information of each of the layers 2, 3 and 4 for the packet received from the user terminal 206, and determines whether or not the contents of the information are consistent with the contents of the entry in the logical link identifier management table 558 (step S684). And the up direction transmission source LLID determination section 556 decides the logical link identifier of transmission source from the consistent conditions. The retrieval of the entry and the decision of the logical link identifier are made in the same way as described in the first embodiment. For example, when the ONU receiving this packet has the ONU number “a” and the service type of the specified packet is “VoIP”, the up direction transmission source LLID determination section 556 decides the logical link-identifier of the packet as “a1”, as shown in FIG. 3. The QoS control section 552 performs the priority control regarding the packet transmission or reception in accordance with the service type corresponding to the kind of the applicable logical link identifier (step S685). If the logical link identifier corresponding to the received packet does not exist in the logical link identifier management table 558, the monitor logical link 511 is allocated as the default. Also, the QoS control section 552 performs the QoS process in accordance with the service type corresponding to the monitor logical link 511 (step S686). After the QoS processing at step S685 or step S686, the logical link control section 551 appends the decided logical link identifier to the packet and transmits the packet to the PON section (step S687).

The PON system 500 of the second embodiment as described above makes it possible to separate the control signal from the primary signal of actual communication traffic. Since the PON system 500 shares the monitor logical link 511 among the ONUs 505-1 to 505-n, the logical link is further saved, so that the utilization efficiency of the network is increased.

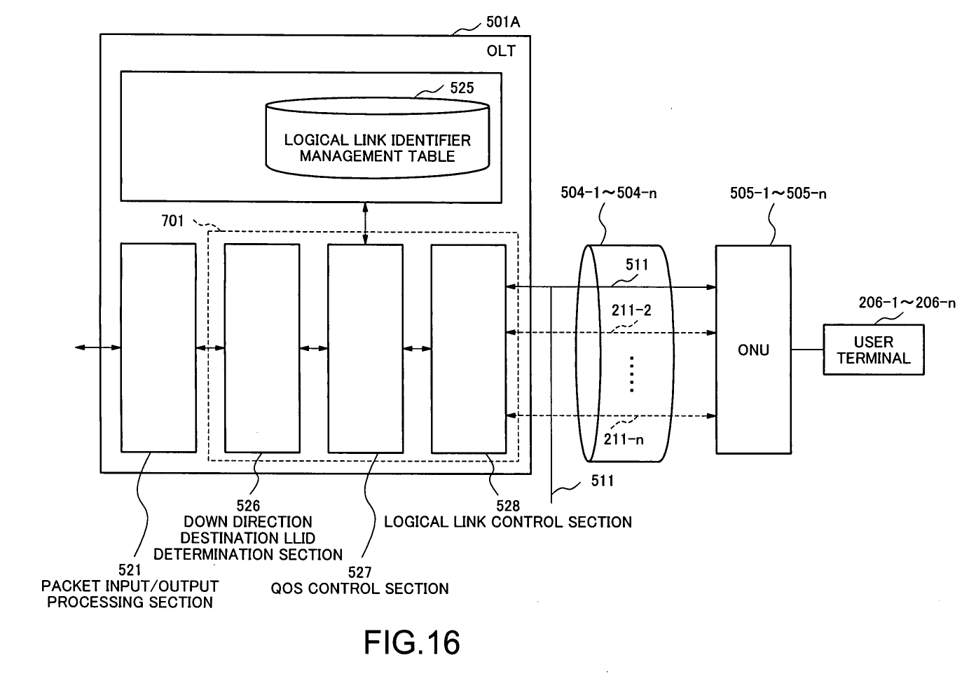

FIG. 16 is a control block diagram of the OLT 501A according to a modified embodiment of the OLT 501 as shown in FIG. 11. A feature of the OLT 501A is that the down direction destination LLID determination section 526, the QoS control section 527 and the logical link control section 528 are modularized as one IC chip 701. A circuit portion closely related with the logical link control is modularized as one chip, whereby if any other circuit portion is changed, the portion related with the logical link control can be diverted. Thereby, the manufacturing cost of the PON system 500 can be reduced, and the design or improvement efficiency of the system can be increased.

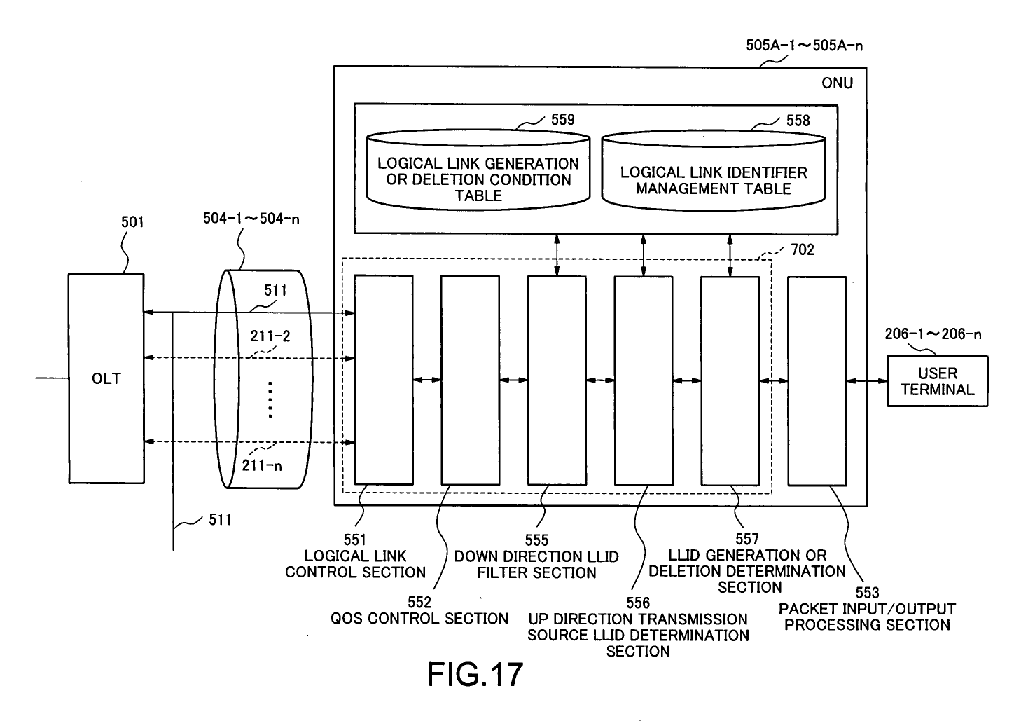

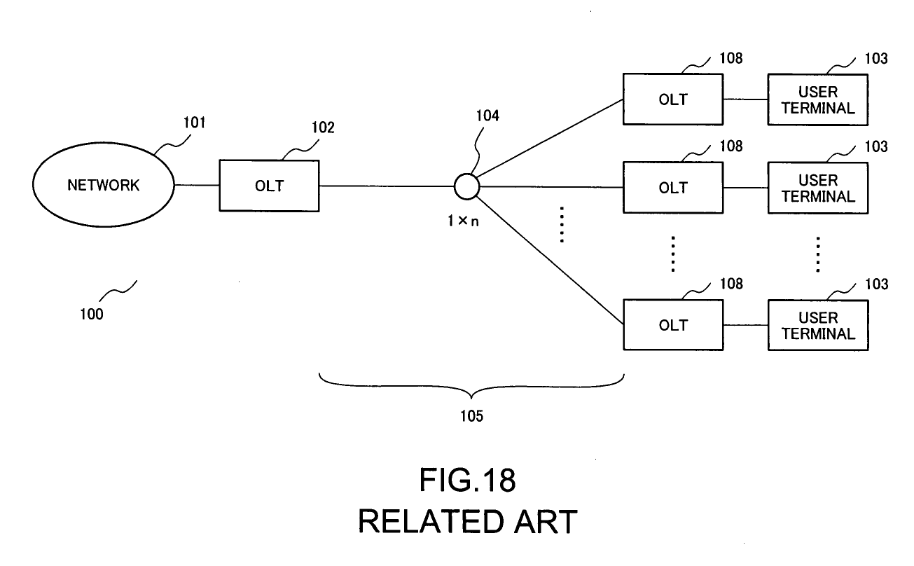

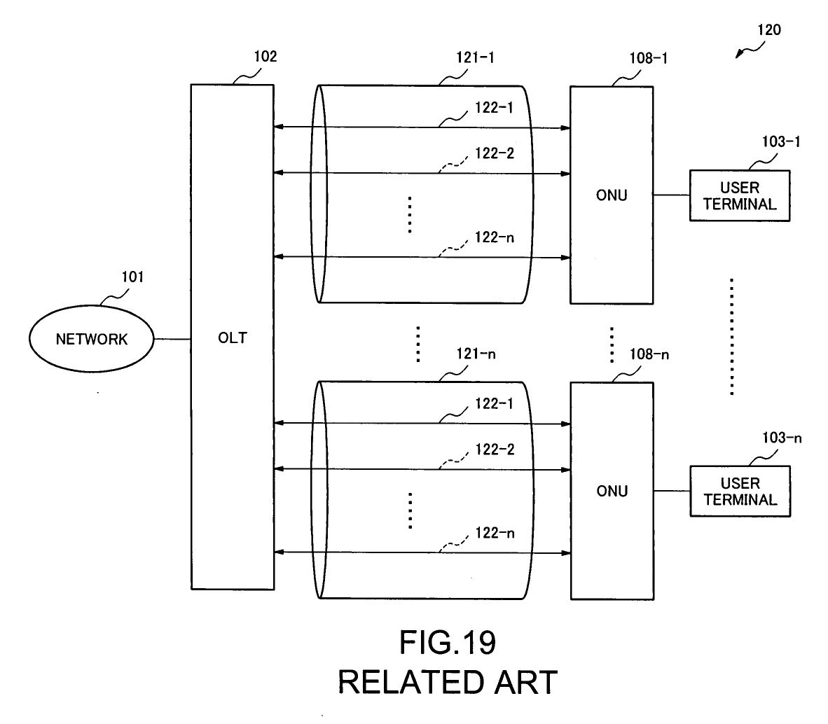

FIG. 17 is a control block diagram of the ONUs 505A-1 to 505A-n according to a modified embodiment of the ONUs 505-1 to 505-n as shown in FIG. 12. A feature of the ONUs 505A-1 to 505A-n is that the logical link control section 551, the QoS control section 552, the down direction LLID filter section 555, the up direction transmission source LLID determination section 556 and the LLID generation or deletion determination section 557 are modularized as one IC chip 702. Accordingly, for the above reason, the manufacturing cost of the PON system 500 can be reduced, and the design or improvement efficiency of the system can be increased.

While this invention has been described in connection with certain exemplary embodiments, it is to be understood that the subject matter encompassed by way of this invention is not to be limited to those specific embodiments. On the contrary, it is intended for the subject matter of the invention to include all alternatives, modifications and equivalents as can be included within the spirit and scope of the following claims.

Further, it is the inventor's intent to retain all equivalents of the claimed invention even if the claims are amended during prosecution.

What is claimed is:

1. A PON system installed in an access network connecting a user terminal to a network, comprising:
an OLT connecting with said network; and
at least one ONU each connected to said OLT via an optical fiber split into a plurality of paths by an optical signal splitter and accommodating said user terminal;
said OLT comprising:
a first logical link management table which manages a logical link allocated in an interval of said optical fiber associated with the information that a passing packet has;
a first update condition definition table which defines the update conditions for adding or deleting the logical link managed by said first logical link management table;
a first table update section which acquires the first information contained in the passing packet, determines whether or not said first information is matched with the update conditions as defined in said first update condition definition table and updates said first logical link management table based on this determination result; and
a first logical link allocation section which acquires the second information contained in a down-stream packet received from said network, determines whether or not said second information is associated with the information as defined in said first logical link management table, and allocates the logical link corresponding to the information as defined in said first logical link management table based on this determination result.

2. The PON system according to claim 1, wherein said OLT further comprises a first QoS control section which controls a QoS of said logical link in accordance with a service type corresponding to the logical link allocated by said first logical link allocation section.

3. The PON system according to claim 1, wherein said ONU further comprises a second logical link management table having the same contents as said first logical link management table provided for said OLT, and a second table update section which updates said second logical link management table, in which the first table update section of said OLT notifies said updated contents to said ONU, if it updates said first logical link management table, and said second table update section updates said second logical link management table in accordance with the updated contents notified from said first table update section.

4. The PON system according to claim 3, wherein said ONU further comprises a second logical link allocation section which acquires the third information contained in an up-stream packet received from said user terminal, determines whether or not said third information is associated with the information as defined in said second logical link management table, and allocates the logical link corresponding to the information as defined in said second logical link management table based on this determination result.

5. The PON system according to claim 4, wherein said ONU further comprises a second QoS control section which controls a QoS of said logical link in accordance with a service type corresponding to the logical link allocated by said second logical link allocation section.

6. The PON system according to claim 5, wherein said first logical link management table and said second logical link management table manage the logical link to be allocated associated with the service type information that the passing packet has.

7. The PON system according to claim 6, wherein said service type information is obtained as a result of peeping into at least one of the layers 2, 3 and 4 of said packet.

8. The PON system according to claim 3, wherein said updated contents are notified by an OAM packet.

9. The PON system according to claim 2, wherein said first table update section, said first logical link allocation section and said first QoS control section, which constitute said OLT, are integrated in one IC chip.

10. The PON system according to claim 5, wherein said second table update section, said second logical link allocation section and said second QoS control section, which constitute said ONU, are integrated in one IC chip.

11. The PON system according to claim 1, wherein a default logical link always communicable with said OLT is set in said optical fiber interval for each said ONU.

12. A PON system installed in an access network connecting a user terminal to a network, comprising:
an OLT connecting with said network; and
a plurality of ONUs connected to said OLT via an optical fiber split into a plurality of paths by an optical signal splitter and accommodating said user terminal;
said ONU comprising:
a third logical link management table which manages a logical link allocated in an interval of said optical fiber associated with the information that a passing packet has;
a second update condition definition table which defines the update conditions for adding or deleting the logical link managed by said third logical link management table;
a third table update section which acquires the fourth information contained in the passing packet, determines whether or not said fourth information is matched with the update conditions as defined in said second update condition definition table and updates said third logical link management table based on this determination result; and
a third logical link allocation section which acquires the fifth information contained in an up-stream packet received from said user terminal, determines whether or not said fifth information is associated with the information as defined in said third logical link management table, and allocates the logical link corresponding to the information as defined in said third logical link management table based on this determination result.

13. The PON system according to claim 12, wherein said ONU further comprises a third QoS control section which controls a QoS of said logical link in accordance with a service type corresponding to the logical link allocated by said third logical link allocation section.

14. The PON system according to claim 12, wherein said OLT further comprises a fourth logical link management table having the same contents as said third logical link management table provided for said ONU, and a fourth table update section which updates said fourth logical link management table, in which the third table update section of said ONU notifies said updated contents to said OLT, if it is determined that said fourth information is matched with the update conditions as defined in said second update condition definition table, said fourth table update section updates said fourth logical link management table in accordance with said updated contents notified from said third table update section and said third table update section updates said third logical link management table in accordance with said updated contents notified from said fourth table update section.

15. The PON system according to claim 14, wherein said OLT further comprises a fourth logical link allocation section which acquires the sixth information contained in a down-stream packet received from said network, determines whether or not said sixth information is associated with the information as defined in said fourth logical link management table, and allocates the logical link corresponding to the information as defined in said fourth logical link management table based on this determination result.

16. The PON system according to claim 15, wherein said OLT further comprises a fourth QoS control section which controls a QoS of said logical link in accordance with a service type corresponding to the logical link allocated by said fourth logical link allocation section.

17. The PON system according to claim 16, wherein said third logical link management table and said fourth logical link management table manage the logical link to be allocated associated with the service type information that the passing packet has.

18. The PON system according to claim 17, wherein said service type information is obtained as a result of peeping into at least one of the layers 2, 3 and 4 of said packet.

19. The PON system according to claim 14, wherein said updated contents are notified by an OAM packet.

20. The PON system according to claim 13, wherein said third table update section, said third logical link allocation section and said third QoS control section, which constitute said ONU, are integrated in one IC chip.

21. The PON system according to claim 16, wherein said fourth table update section, said fourth logical link allocation section and said fourth QoS control section, which constitute said OLT, are integrated in one IC chip.

22. The PON system according to claim 12, wherein a default logical link always communicable with said OLT as well as being shared among a plurality of said ONUs is set in said optical fiber interval.

23. A logical link allocation method for use in a PON system installed in an access network connecting a user terminal to a network, said PON system comprising:
an OLT connecting with said network; and
at least one ONU each connected to said OLT via an optical fiber split into a plurality of paths by an optical signal splitter and accommodating said user terminal;
said OLT comprising:
a first logical link management table which manages a logical link allocated in an interval of said optical fiber associated with the information that a passing packet has;
said method comprising:
setting a first update condition definition table defining the update conditions for adding or deleting the logical link managed by said first logical link management table;
acquiring the first information contained in the passing packet;
determining whether or not said first information is matched with the update conditions as defined in said first update condition definition table;
updating said first logical link management table based on this determination result;
acquiring the second information contained in a down-stream packet received from said network;
determining whether or not said second information is associated with the information as defined in said first logical link management table; and
allocating the logical link corresponding to the information as defined in said first logical link management table based on this determination result.

24. The logical link allocation method according to claim 23, further comprising a step of controlling a QoS of said logical link in accordance with a service type corresponding to the logical link allocated at said logical link allocation step in said OLT.

25. The logical link allocation method according to claim 23, wherein said ONU comprises a second logical link management table having the same contents as said first logical link management table, and said method further comprising receiving said updated contents from said OLT and updating said second logical link management table in accordance with said received updated contents, if said first logical link management table is updated.

26. The logical link allocation method according to claim 25, further comprising acquiring the third information contained in an up-stream packet received from said user terminal in said ONU, determining whether or not said third information is associated with the information as defined in said second logical link management table, and allocating the logical link corresponding to the information as defined in said second logical link management table based on this determination result.

27. The logical link allocation method according to claim 26, further comprising controlling a QoS of said logical link in accordance with a service type corresponding to the logical link allocated at said logical link allocation step in said ONU.

28. A logical link allocation method for use in a PON system which a user terminal is installed in an access network connecting to a network, said PON system comprising:
an OLT connecting with said network; and
a plurality of ONUs connected to said OLT via an optical fiber split into a plurality of paths by an optical signal splitter and accommodating said user terminal;
said ONU comprising:
a third logical link management table which manages a logical link allocated in an interval of said optical fiber associated with the information that a passing packet has;
said method comprising:
setting a second update condition definition table defining the update conditions for adding or deleting the logical link managed by said third logical link management table;
acquiring the fourth information contained in the passing packet;
determining whether or not said fourth information is matched with the update conditions as defined in said second update condition definition table;
updating said third logical link management table based on this determination result;
acquiring the fifth information contained in an up-stream packet received from said user terminal;
determining whether or not said fifth information is associated with the information as defined in said third logical link management table; and
allocating the logical link corresponding to the information as defined in said third logical link management table based on this determination result.

29. The logical link allocation method according to claim 28, further comprising a step of controlling a QoS of said logical link in accordance with a service type corresponding to the logical link allocated at said logical link allocation step in said ONU.

30. The logical link allocation method according to claim 28, wherein said OLT comprises a fourth logical link management table having the same contents as said third logical link management table, and said method further comprising receiving said updated contents from said ONU, updating said fourth logical link management table in accordance with said received updated contents and notifying said updated contents to said ONU, if it is determined that said fourth information is matched with the update conditions as defined in said second update condition definition table, and updating said third logical link management table in accordance with said updated contents notified from said OLT in said ONU.

31. The logical link allocation method according to claim 30, further comprising acquiring the sixth information contained in a down-stream packet received from said network in said OLT, determining whether or not said sixth information is associated with the information as defined in said fourth logical link management table, and allocating the logical link corresponding to the information as defined in said fourth logical link management table based on this determination result.

32. The logical link allocation method according to claim 31, further comprising controlling a QoS of said logical link in accordance with a service type corresponding to the logical link allocated at said logical link allocation step in said OLT.
